(19) United States
(12) Patent Application Publication
(10) Pub. No.: US 2018/0202818 A1
(43) Pub. Date: Jul. 19, 2018

(54) SYSTEMS AND METHODS FOR DISTRIBUTING REQUEST FOR SERVICE

(71) Applicant: BEIJING DIDI INFINITY TECHNOLOGY AND DEVELOPMENT CO., LTD., Beijing (CN)

(72) Inventor: Lingyu ZHANG, Beijing (CN)

(73) Assignee: BEIJING DIDI INFINITY TECHNOLOGY AND DEVELOPMENT CO., LTD., Beijing (CN)

(21) Appl. No.: 15/566,456

(22) PCT Filed: Mar. 14, 2017
(86) PCT No.: PCT/CN2017/076597

§ 371 Date: Oct. 13, 2017

(30) Foreign Application Priority Data
May 23, 2016 (CN) 201610345474.9

(51) Int. Cl. G01C 21/34; G06Q 50/30; H04W 4/02

(52) U.S. Cl. CPC G01C 21/3407; G06Q 30/0635; H04W 4/027; G06Q 50/30

(57) ABSTRACT

The present disclosure relates to a system, method and non-transitory computer readable medium. The system may include at least one computer-readable storage medium including a set of instructions and at least one processor in communication with the at least one computer-readable storage medium. When executing the instructions, the at least one processor is directed to: receive a request for a service including a destination; obtain an area associated with a service provider terminal; determine a probability that the destination is within the area associated with the service provider terminal; determine whether the probability that the destination is within the area associated with the service provider terminal is larger than a threshold; and in response to the determination that the probability that the destination is within the area associated with the service provider terminal is larger than the threshold, determine the service provider terminal as a candidate service provider terminal.

### CROSS-REFERENCE TO RELATED APPLICATION

The present application claims priority of Chinese Application No. CN 201610345474.9 filed on May 23, 2016, the content of which is hereby incorporated by reference in its entirety.

### TECHNICAL FIELD

The present application relates generally to a system and method for operating an on-demand service, and in particular, a system and method for distributing a request for an on-demand service.

### BACKGROUND

On-demand service plays a significant role in people's daily life. For example, on-demand transportation service may be heavily used by a user (e.g., a passenger). Platforms of the on-demand transportation service may dynamically assign a request for transportation service including a destination to a driver terminal. However, in some scenarios, a driver corresponding to the assigned driver terminal may be not familiar with the destination and/or the departure location of the passenger. In such condition, the transportation service provided by the driver may incur extra cost and time. Subsequently, the passenger may have unsatisfactory service experience.

### SUMMARY

According to an aspect of the present disclosure, a system may include at least one computer-readable storage medium including a set of instructions and at least one processor in communication with the at least one computer-readable storage medium. When executing the instructions, the at least one processor is directed to: receive a request for a service including a destination; obtain an area associated with a service provider terminal; determine a probability that the destination is within the area associated with the service provider terminal; determine whether the probability that the destination is within the area associated with the service provider terminal is larger than a threshold; and in response to the determination that the probability that the destination is within the area associated with the service provider terminal is larger than the threshold, determine the service provider terminal as a candidate service provider terminal.

According to an aspect of the present disclosure, a method implemented on a computing device having at least one processor, at least one computer-readable storage medium, and a communication platform connected to a network may include receiving a request for a service including a destination; obtaining an area associated with a service provider terminal; determining a probability that the destination is within the area associated with the service provider terminal; determining whether the probability that the destination is within the area associated with the service provider terminal is larger than a threshold; and in response to the determination that the probability that the destination is within the area associated with the service provider terminal is larger than the threshold, determining the service provider terminal as a candidate service provider terminal.

According to an aspect of the present disclosure, a non-transitory computer readable medium may include instructions configured to cause a computing system to: receive a request for a service including a destination; obtain an area associated with a service provider terminal; determine a probability that the destination is within the area associated with the service provider terminal; determine whether the probability that the destination is within the area associated with the service provider terminal is larger than a threshold; and in response to the determination that the probability that the destination is within the area associated with the service provider terminal is larger than the threshold, determine the service provider terminal as a candidate service provider terminal.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram of an exemplary on-demand service system according to some embodiments;

FIG. 2 is a block diagram illustrating an exemplary computing device in the on-demand service system according to some embodiments of the present disclosure;

FIG. 3 is a block diagram illustrating an exemplary processing engine according to some embodiments of the present disclosure;

FIG. 4 shows an exemplary process 400 for sending a request for a service to a service provider terminal based on a probability that the destination is within the area associated with the service provider terminal according to some embodiments of the present disclosure;

FIG. 5 shows an exemplary process 500 for obtaining the area associated with the service provider terminal according to some embodiments of the present disclosure;

FIG. 6 shows an exemplary process 600 for determining a probability that the destination is within the area associated with the service provider terminal according to some embodiments of the present disclosure; and

FIG. 7 shows an exemplary process 700 for sending the request for the service to a target service provider terminal according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to distributing a request for a transportation service, it should also be understood that the present disclosure is not intended to be limiting. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The term “passenger,” “requestor,” “service requestor,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requestor, a customer, a driver, a provider, a service provider, or the like, or any combination thereof. The service request may be accepted by any one of a passenger, a service requestor, a customer, a driver, a provider, or a service provider. The service request may be chargeable or free.

The term “service provider terminal” and “driver terminal” in the present disclosure are used interchangeably to refer to a mobile terminal that is used by a service provider to provide a service or facilitate the providing of the service. The term “service requestor terminal” and “passenger terminal” in the present disclosure are used interchangeably to refer to a mobile terminal that is used by a service requestor to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

According to an aspect of the present disclosure, on-demand service systems and methods for distributing a request for a service are provided. The on-demand service system receives a service request including a destination. The on-demand service system obtains an area associated with a service provider terminal. The on-demand service system determines a probability that the destination is within the area associated with the service provider terminal. When the probability that the destination is within the area associated with the service provider terminal is larger than a threshold, the on-demand service system determines the service provider terminal as a candidate service provider terminal and sends the service request to the candidate service provider terminal.

It should be noted that the online on-demand transportation service, such as online taxi hailing, is a newly emerged service rooted in post-Internet era. It provides the technical solutions to the passengers and drivers that could raise only in post-Internet era. In the pre-Internet era, when a passenger hails a taxi on the street, the passenger may have no knowledge of the familiarity of the taxi driver with his/her destination. If the passenger hails a taxi through a telephone call, it may be difficult for the service provider (e.g., a taxi company or an agent) to find a taxi driver familiar with the destination of the passenger. Besides, it may consume a lot of time and resources to find the competent driver familiar with the destination. Online on-demand transportation system, however, allows a user of the service to send a real-time service request via a user device to a server of an online on-demand transportation system. Before assigning the service request to a driver, the online on-demand transportation system may determine a competent driver familiar with the destination of the user. By assigning the service request to the competent driver familiar with the destination of the user, the online on-demand transportation system may provide a convenient and efficient service to the user and enhance the user experience. The online on-demand service system is also able to choose a competent driver familiar with the destination among a huge number of drivers in a relatively short period of time. The time interval between initiating the service request and assigning the service request may be reduced. Therefore, through Internet, the online on-demand transportation systems may provide a much more convenient and efficient transaction platform for the passengers and the drivers that may never be met in a traditional pre-Internet transportation service system.

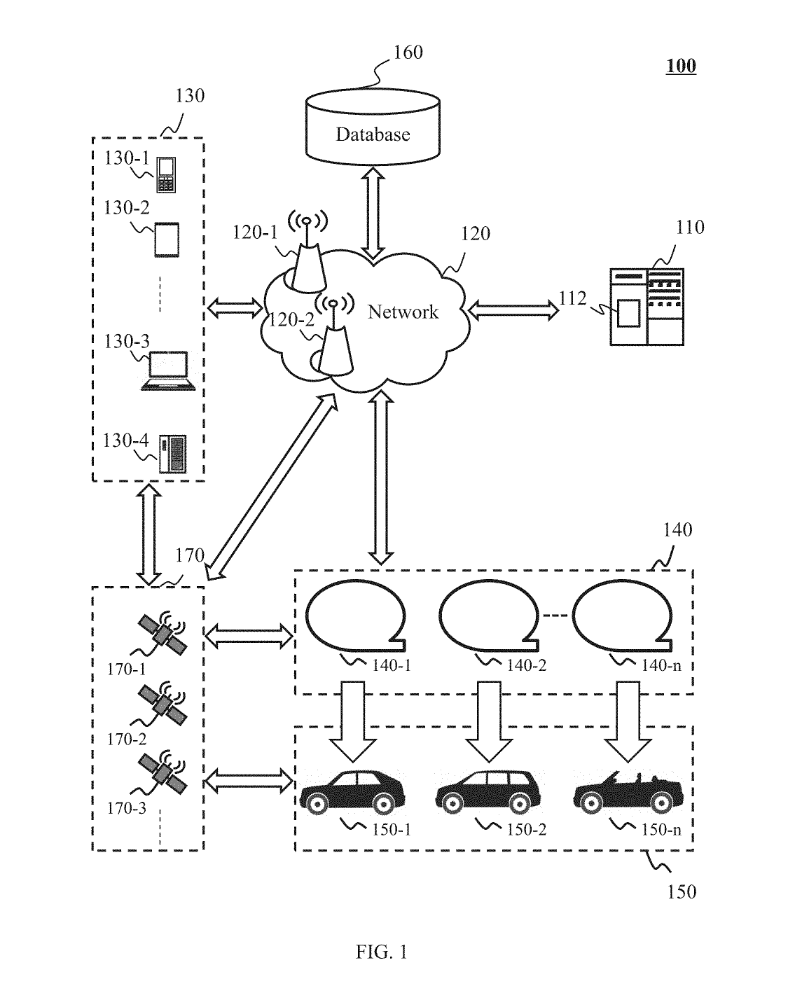

FIG. 1 is a block diagram of an exemplary on-demand service system 100 according to some embodiments. For example, the on-demand service system 100 may be an online transportation service platform for transportation services. The on-demand service system 100 may include a server 110, a network 120, a passenger terminal 130, a service provider terminal 140, a vehicle 150, a database 160, and a navigation system 170.

The on-demand service system 100 may provide a plurality of services. Exemplary service may include a taxi hailing service, a chauffeur service, an express car service, a carpool service, a bus service, a driver hire service, and a shuttle service. In some embodiments, the on-demand service may be any on-line service, such as booking a meal, shopping, or the like, or a combination thereof.

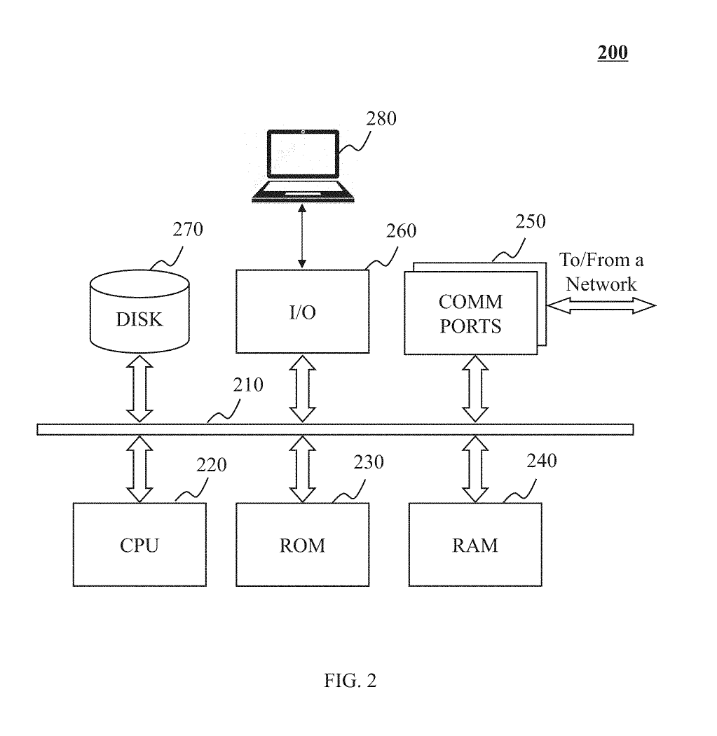

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the passenger terminal 130, the service provider terminal 140, and/or the database 160 via the network 120. As another example, the server 110 may be directly connected to the passenger terminal 130, the service provider terminal 140, and/or the database 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine one or more candidate service provider terminals in response to the service request received from the passenger terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the passenger terminal 130, the service provider terminal 140, the vehicle 150, the database 160, and the navigation system 170) may send information and/or data to other component(s) in the on-demand service system 100 via the network 120. For example, the server 110 may receive a service request from the passenger terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a passenger may be an owner of the passenger terminal 130. In some embodiments, the owner of the passenger terminal 130 may be someone other than the passenger. For example, an owner A of the passenger terminal 130 may use the passenger terminal 130 to send a service request for a passenger B, or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably. In some embodiments, the service provider terminal may be associated with one or more service providers (e.g., a night-shift service provider, or a day-shift service provider).

In some embodiments, the passenger terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the vehicle 130-4 may include an onboard computer, an onboard television, etc. In some embodiments, the passenger terminal 130 may be a device with positioning technology for locating the position of the passenger and/or the passenger terminal 130.

The service provider terminal 140 may include a plurality of service provider terminals 140-1, 140-2, . . . , 140-n. In some embodiments, the service provider terminal 140 may be similar to, or the same device as the passenger terminal 130. In some embodiments, the service provider terminal 140 may be customized to be able to implement the online on-demand transportation service. In some embodiments, the service provider terminal 140 may be a device with positioning technology for locating the service provider, the service provider terminal 140, and/or a vehicle 150 associated with the service provider terminal 140. In some embodiments, the passenger terminal 130 and/or the service provider terminal 140 may communicate with other positioning device to determine the position of the passenger, the passenger terminal 130, the service provider, and/or the service provider terminal 140. In some embodiments, the passenger terminal 130 and/or the service provider terminal 140 may periodically send the positioning information to the server 110. In some embodiments, the service provider terminal 140 may also periodically send the availability status to the server 110. The availability status may indicate whether a vehicle 150 associated with the service provider terminal 140 is available to carry a passenger. For example, the passenger terminal 130 and/or the service provider terminal 140 may send the positioning information and the availability status to the server 110 every thirty minutes. As another example, the passenger terminal 130 and/or the service provider terminal 140 may send the positioning information and the availability status to the server 110 each time the user logs into the mobile application associated with the online on-demand transportation service.

In some embodiments, the service provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi hailing service, a chauffeur service, an express car service, a carpool service, a bus service, a driver hire service, and a shuttle service).

The database 160 may store data and/or instructions. In some embodiments, the database 160 may store data obtained from the passenger terminal 130 and/or the service provider terminal 140. In some embodiments, the database 160 may store data and/or instructions that the server 110 may execute or use to perform exemplary methods described in the present disclosure. In some embodiments, database 160 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 160 may be connected to the network 120 to communicate with one or more components in the on-demand service system 100 (e.g., the server 110, the passenger terminal 130, the service provider terminal 140, etc.). One or more components in the on-demand service system 100 may access the data or instructions stored in the database 160 via the network 120. In some embodiments, the database 160 may be directly connected to or communicate with one or more components in the on-demand service system 100 (e.g., the server 110, the passenger terminal 130, the service provider terminal 140, etc.). In some embodiments, the database 160 may be part of the server 110.

The navigation system 170 may determine information associated with an object, for example, one or more of the passenger terminal 130, the service provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may send the information mentioned above to the network 120, the passenger terminal 130, the service provider terminal 140, or the vehicle 150 via wireless connections.

In some embodiments, one or more components in the on-demand service system 100 (e.g., the server 110, the passenger terminal 130, the service provider terminal 140, etc.) may have permissions to access the database 160. In some embodiments, one or more components in the on-demand service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components in the on-demand service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the computer server 110, the passenger terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer. Both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown for convenience, the computer functions related to the on-demand service as described herein may be implemented in a distributed manner on a number of similar platforms to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, the CPU and/or processor of the computing device 200 executes both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

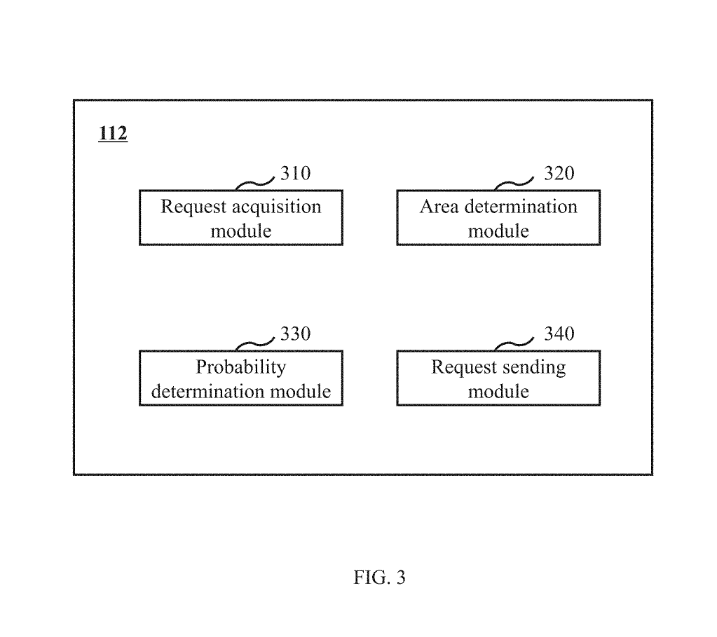

FIG. 3 is a block diagram illustrating an exemplary processing engine 112 according to some embodiments of the present disclosure. The processing engine 112 may include a request acquisition module 310, an area determination module 320, a probability determination module 330, and a request sending module 340.

The request acquisition module 310 may obtain a request for a service from a passenger terminal, a server for the on-demand service, or other sources. The request for the service may be a request for a transportation service. The request for a transportation service may refer to a request for a carpooling, a request for a taxi, any request for a vehicle, or the like, or any combination thereof. For example, a passenger may initiate the request for a taxi service from a departure location to a destination. In some embodiments, the request for the service may be the request for a deliver service (e.g., delivering a document or food to a certain address).

In some embodiments, the request for the service may include geographical information, temporal information, or other information. The geographical information may include a departure location, a destination, a pickup location, a current location of a passenger, etc. The temporal information may include an expected pickup time, an expected driving time, an expected arrival time, etc. Other information may include a name of the passenger, contact information, any other information related to the service or the passenger, or the like, or any combination thereof.

The area determination module 320 may determine an area associated with a service provider terminal. The area associated with a service provider terminal may describe an area that a service provider associated with the service provider terminal may be familiar with. The area may correspond to a specific area in a two dimensional space, a specific area in a three dimensional space, or a specific area in a map. In some embodiments, the area may correspond to one or more geographical areas on a map. For example, the area may be a circular area centered on an airport with a radius of five (5) kilometers. In some embodiments, the area may have other shape other than a circular, such as, an elliptic shape, a triangular shape, a rectangular shape, a square, a diamond, etc. In some embodiments, the area may follow the administrative borders of the city and/or county. As another example, the area may be a plurality of individual areas distributed within a city. In some embodiments, the area may be time-dependent. For example, there may be a night-shift area for a night-shift service provider.

The probability determination module 330 may determine a probability that the destination included in the request of service is within the area associated with the service provider terminal based on the request of a service and the area associated with the service provider terminal. The probability may indicate the familiarity of the service provider with the destination of the request for the service. The probability may be a value ranged between 0 and 1, a percentage ranged between 0% and 100%, or the like, or any combination thereof. In some embodiments, when the probability is larger than a certain threshold, it is determined that the service provider associated with the service provider terminal is familiar with the destination included in the request for the service.

The request sending module 340 may send the request for the service to the service provider terminal based on the probability that the destination is within the area associated with the service provider terminal. The request sending module 340 may send the request for the service to one or more service provider terminals based on the probabilities associated with the one or more service provider terminals. In some embodiments, the request sending module 340 may send the request for the service to a service provider terminal associated with a maximal probability.

The request acquisition module 310, the area determination module 320, the probability determination module 330, and the request sending module 340 in the processing engine 112 may be connected to or communicate with each other via a wired connection, a wireless connection, or any combination thereof. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the request acquisition module 310, the area determination module 320, the probability determination module 330, and the request sending module 340 may be combined as a single module. For example, the probability determination module 330 may be integrated with the request sending module 340 as a single module. The single module may determine the probability that the destination is within the area associated with the service provider terminal and send the request for the service to the service provider terminal based on the probability.

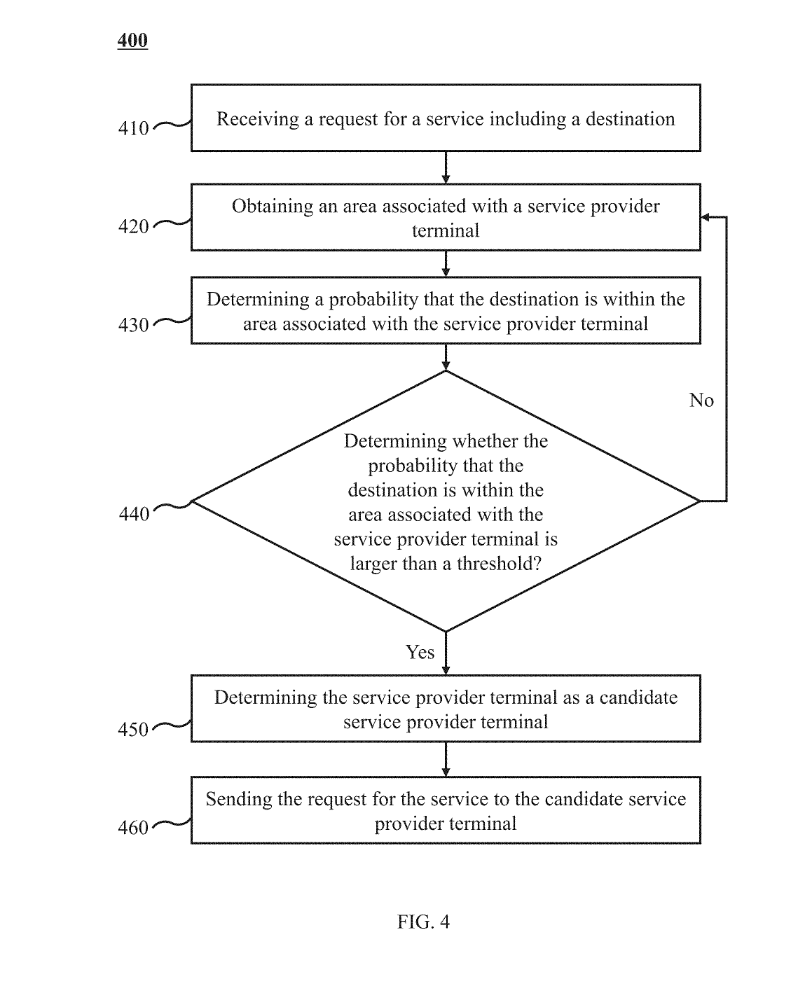

FIG. 4 shows an exemplary process 400 for sending a request for a service to a service provider terminal based on a probability that the destination is within the area associated with the service provider terminal according to some embodiments of the present disclosure. The process 400 may be implemented as a set of instructions in a non-transitory storage medium of the computer server 110 of the system 100. The CPU 220 of the computer server 110 may execute the set of instructions and may accordingly perform the steps in the process 400.

The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 4 and described below is not intended to be limiting.

In step 410, the request acquisition module 310 may receive a request for a service including a destination from a user via a passenger device 130 (shown in FIG. 1). In some embodiments, the request for the service may be initiated and/or sent by a passenger terminal. In some embodiments, the request for the service may be sent or relayed by a server. In some embodiments, the request acquisition module 310 may receive the request for the service through a wired communication or a wireless communication.

In step 420, the area determination module 320 may obtain an area associated with a service provider terminal. In some embodiments, the area may be a pre-generated area stored in a web server, a database (for example, the database 160), the ROM 230, or the disk 270, etc. The area may be part of profile information of the service provider or the service provider terminal. In some embodiments, the area determination module 320 may determine the area in a real-time manner. In some embodiments, the area determination module 320 may determine a plurality of areas for a plurality of service provider terminals. Each area may correspond to one service provider terminal respectively. For example, the area determination module 320 may determine three different areas corresponding to three service provider terminals respectively. In some embodiments, the area determination module 320 may determine one or more areas for one service provider terminal.

In step 430, the probability determination module 330 may determine a probability that the destination is within the area associated with the service provider terminal. In some embodiments, the probability may be determined based on the destination and the area associated with the service provider terminal.

In step 440, the probability determination module 330 may determine whether the probability that the destination is within the area associated with the service provider terminal is larger than a threshold. The threshold may be a value ranged between 0 and 1 or a percentage ranged between 0% and 100%.

The threshold may be determined by the system 100 or designated by a passenger. The system 100 may determine the threshold based on one or more factors. The one or more factors may include a degree of sophistication of the road network, a dimension of the area (a city, a suburban area, a town, etc.), real-time conditions (weather, time, or road condition). The passenger may designate the threshold according to his/her need or real-time conditions.

When the probability determination module 330 determines the probability that the destination is within the area associated with the service provider terminal is larger than the threshold, the process may enter into step 450. When the probability determination module 330 determines the probability that the destination is within the area associated with the service provider terminal is not larger than the threshold, the process may return to step 420.

In step 450, the request sending module 340 may determine the service provider terminal as a candidate service provider terminal. In some embodiments, the request sending module 340 may determine a plurality of candidate service provider terminals. For example, the request sending module 340 may determine three (3) candidate service provider terminals. Each of the three candidate service provider terminals may be associated with a probability larger than the threshold.

In step 460, the request sending module 340 may send the request for the service to the candidate service provider terminal. The request sending module 340 may send the request for the service immediately after the step 450 or in a delayed manner. For example, if the request for the service is a reservation request for the service with a designated future pickup time, the request sending module 340 may not send the request for the service to the candidate service provider terminal(s) immediately. Instead, the request sending module 340 may send the request for the service to the candidate service provider terminal in a time period prior to the designated future pickup time.

In some embodiments, the passenger terminal 130 may simultaneously display the locations of the passenger terminal 130 and one or more candidate service provider terminals on a user interface of a mobile application associated with the online on-demand transportation service. The displayed locations of the one or more candidate service provider terminals may dynamically change on the user interface. When one of the one or more candidate service provider terminals accepts the request from the user, the user interface may display the information related to the candidate service provider terminal who accepts the request for the user confirmation. Once a user confirmation is received at the candidate service provider terminal who accepts the request, the service provider associated with the service provider terminal may drive to pick up the user at the departure location.

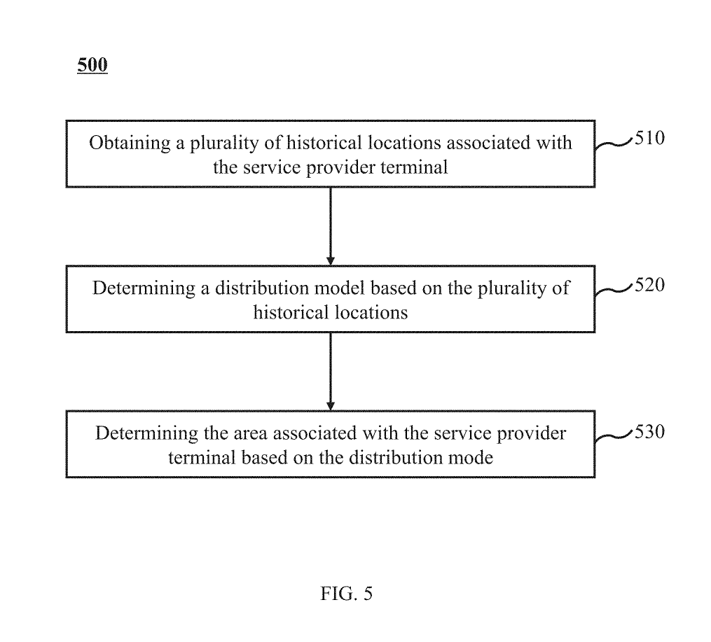

FIG. 5 shows an exemplary process 500 for obtaining the area associated with the service provider terminal according to some embodiments of the present disclosure. The process 500 may be implemented as a set of instructions in a non-transitory storage medium of the computer server 110 of the system 100. The CPU 220 of the computer server 110 may execute the set of instructions and may accordingly perform the steps in the process 500.

The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 5 and described below is not intended to be limiting.

In step 510, the area determination module 320 may obtain a plurality of historical locations associated with the service provider terminal. The historical locations may be extracted from one or more historical driving routes. A historical driving route may include one or more locations between a starting location (e.g., a pickup location for a taxi journey) and a destination.

The plurality of historical locations may include a plurality of historical geographical coordinates. For example, each of the historical geographical coordinates may include a longitude coordinate x and a latitude coordinate y. For example, a set including n (a positive integer) historical geographical coordinates may be described as {(x₁,y₁), (x₂,y₂), (x₃,y₃), . . . , (xₙ,yₙ)}.

In some embodiments, the plurality of historical locations may include a plurality of historical address descriptions. The system 100 may convert the plurality of historical address descriptions to a plurality of historical geographical coordinates.

In step 520, the area determination module 320 may determine a distribution model based on the plurality of historical locations. The area determination module 320 may use the historical locations of the service provider terminal as training sets. The training sets may be used to derive or modify the distribution model.

In some embodiments, the distribution model may include a normal distribution function, a Poisson distribution function, an exponential distribution function, any other distribution model, or the like, or any combination thereof. The normal distribution function may include a one-dimensional normal distribution function or a two-dimensional normal distribution function.

In some embodiments, the two-dimensional normal distribution function may have two variables. One variable may be a longitude coordinate x. The other variable may be a latitude coordinate y. The two-dimensional normal distribution function may be shown as:

$$f ( x , y ) = \frac{1}{2 {πσ}_{1} {σ}_{2} \sqrt{1 - {ρ}^{2}}} exp \{ \frac{- 1}{2 ( 1 - {ρ}^{2} )} [ \frac{{( x - {μ}_{1} )}^{2}}{{σ}_{1}^{2}} - 2 ρ \frac{( x - {μ}_{1} ) ( y - {μ}_{2} )}{{σ}_{1} {σ}_{2}} + \frac{{( y - {μ}_{2} )}^{2}}{{σ}_{2}^{2}} ] \} . \qquad ( 1 )$$

Here ƒ denotes a distribution probability. σ₁ denotes a standard deviation of the variable x. σ₂ denotes a standard deviation of the variable y. ρ denotes the correlation between x and y. μ₁ denotes an expectation of the variable x. μ₂ denotes an expectation of the variable y. In some embodiments, ρ may equal to 0, indicating that the two variables x and y are independent to each other.

In some embodiments, the longitude coordinate x may follow a one-dimensional normal distribution N(μ₁, σ₁). The latitude coordinate y may follow a one-dimensional normal distribution N(μ₂, σ₂).

The expectation μ₁ may be determined based on equation (2):

$${μ}_{1} = {Σ}_{1}^{n} \frac{{x}_{i}}{n} . \qquad ( 2 )$$

The expectation μ₂ may be determined based on equation (3):

$${μ}_{2} = {Σ}_{1}^{n} \frac{{y}_{j}}{n} . \qquad ( 3 )$$

The standard deviation σ₁ may be determined based on equation (4):

$${σ}_{1} = {Σ}_{1}^{n} \frac{{( {x}_{i} - {μ}_{1} )}^{2}}{n} . \qquad ( 4 )$$

The standard deviation σ₂ may be determined based on equation (5):

$${σ}_{2} = {Σ}_{1}^{n} \frac{{( {y}_{j} - {μ}_{2} )}^{2}}{n} . \qquad ( 5 )$$

Here, i and j are both indices for the summations. n is the number of samples.

In step 530, the area determination module 320 may determine the area associated with the service provider terminal based on the distribution model. In some embodiments, the area determination module 320 may determine a probability-dense region of the distribution model.

In some embodiments, the area determination module 320 may generate a graph according to the distribution model in a three-dimensional space. The three-dimensional space may have three axes. A first axis may represent the longitude coordinate (x). A second axis may represent the latitude coordinate (y). And a third axis may represent a distribution probability. The longitude coordinate (x) and the latitude coordinate (y) may jointly form a plane O_{xy}. The area determination module 320 may project a graph of the distribution model in the three-dimensional space to the plane O_{xy} and generate a projected graph of the probability density. There may be one or more maxima. Each maximum may correspond to a local or global maximum of the probability density.

When the distribution model is a two-dimensional normal distribution function, the area determination module 320 may generate a graph having a peak (μ₁,μ₂, ƒ(μ₁,μ₂)). Projection of the graph of the two-dimensional normal distribution function may be centered on a point (μ₁,μ₂) in the plane O_{xy}. The point (μ₁,μ₂) may have a maximal distribution probability ƒ(μ₁,μ₂).

In some embodiments, the area determination module 320 may determine a probability-dense region in the plane O_{xy} based, at least in part on the distribution model. The probability-dense region may have a higher density of probability than any other region. The area determination module 320 may determine the probability-dense region as the area associated with the service provider terminal.

When the distribution model is a two-dimensional normal distribution function, the probability-dense region may be a specific region that is around or close to the point (μ₁,μ₂). In some embodiments, the probability-dense region may be centered on or close to the point (μ₁,μ₂). For example, the probability-dense region may be a circular or an elliptic region centered on the point (μ₁,μ₂). When the probability-dense region is a circle, it may have a radius, for example, σ₁, σ₂, or any other value. When the probability-dense region is an ellipse, it may have a major radius and a minor radius. The major radius may be a larger value between σ₁ and σ₂, or any other value. The minor radius may be a smaller value between σ₁ and σ₂, or any other value. In some embodiments, the probability-dense region may have other shape other than a circular or an elliptic shape, such as, a triangular shape, a rectangular shape, a square, a diamond, etc. In some embodiments, the probability-dense region may follow the administrative borders of the city and/or county.

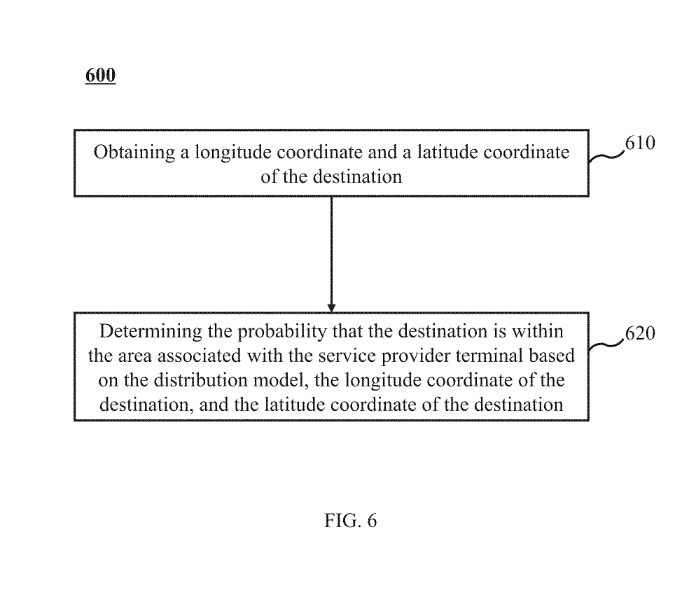

FIG. 6 shows an exemplary process 600 for determining a probability that the destination is within the area associated with the service provider terminal according to some embodiments of the present disclosure. The process 600 may be implemented as a set of instructions in a non-transitory storage medium of the computer server 110 of the system 100. The CPU 220 of the computer server 110 may execute the set of instructions and may accordingly perform the steps in the process 600.

The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 6 and described below is not intended to be limiting.

In step 610, the probability determination module 330 may obtain a longitude coordinate and a latitude coordinate of the destination. In some embodiments, a longitude coordinate and a latitude coordinate of the destination may be obtained from the request for the service directly. For example, a passenger may initiate the request for the service with the destination by inputting geographical coordinates (i.e., the longitude coordinate (x) and latitude coordinate (y)). The probability determination module 330 may identify the geographical coordinates from the request for the service. In some embodiments, the probability determination module 330 may obtain an address description (e.g., a name of a building, a station, etc.). The probability determination module 330 may convert the address description to a corresponding geographical coordinate that includes the longitude coordinate (x) and latitude coordinate (y). For example, a passenger may initiate the request for the service with the destination by inputting Zhongguancun Subway Station, and the probability determination module 330 may determine the longitude coordinate (x) and latitude coordinate (y) of the destination corresponding to Zhongguancun Subway Station.

In step 620, the probability determination module 330 may determine the probability that the destination is within the area associated with the service provider terminal based on the distribution model, the longitude coordinate of the destination, and the latitude coordinate of the destination.

In some embodiments, the probability determination module 330 may determine the probability that the destination is within the area associated with the service provider terminal by determining an integral corresponding to the longitude coordinate (x) and the latitude coordinate (y) of the destination. For example, when the distribution model is the two-dimensional normal distribution function ƒ(x,y) shown in equation (1), the probability that the destination is within the area associated with the service provider terminal may be determined as:

W=∫∫ƒ(x,y)dxdy (6).

Here, W denotes the probability that the destination is within the area associated with the service provider terminal.

In some scenarios, the system 100 may determine multiple candidate service provider terminals. The system 100 may choose one service provider terminal among the multiple candidate terminals as a target service provider terminal based on the calculated probabilities that the destination is within the areas associated with the multiple candidate service provider terminals. Compared with other service providers associated with the candidate terminals other than the target service provider terminal, the service provider associated with the target service provider terminal may be more familiar with the destination included in the request for the service. Thus, the service provider associated with the target service provider terminal may be able to provide a more convenient and efficient service to the passenger. The system 100 may send the request for the service to the target service provider terminal.

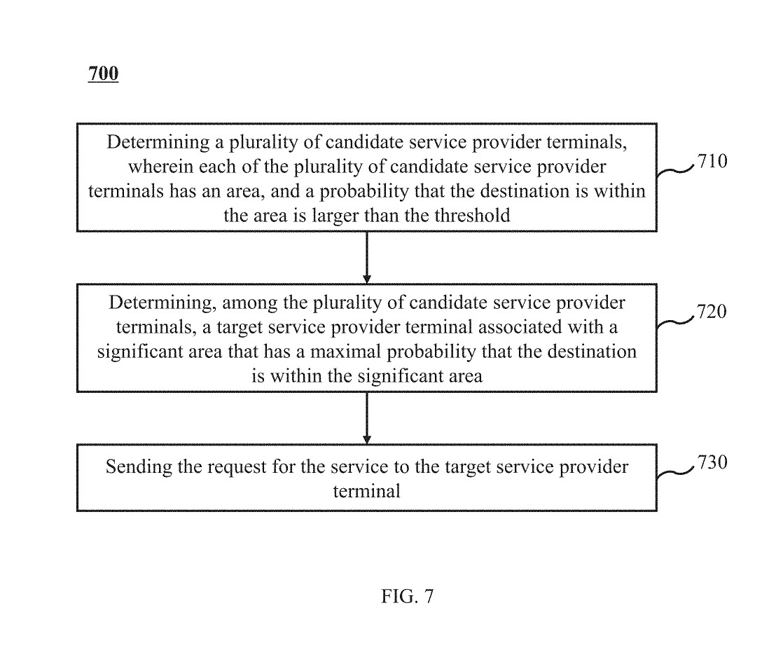

FIG. 7 shows an exemplary process 700 for sending the request for the service to the target service provider terminal according to some embodiments of the present disclosure. The process 700 may be implemented as a set of instructions in a non-transitory storage medium of the computer server 110 of the system 100. The CPU 220 of the computer server 110 may execute the set of instructions and may accordingly perform the steps in the process 700.

The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 7 and described below is not intended to be limiting.

In step 710, the request sending module 340 may determine a plurality of service provider terminals as a plurality of candidate service provider terminals. Each of the plurality of candidate service provider terminals may have an area and a probability that the destination is within the area is larger than the threshold. For the determination of the candidate service provider terminal, reference may be made to description in connection with FIG. 4.

In step 720, the request sending module 340 may determine, among the plurality of candidate service provider terminals, a target service provider terminal. The target service provider terminal may be associated with a significant area that has a maximal probability that the destination is within the significant area. In some embodiments, the request sending module 340 may obtain the probability corresponding to each of the plurality of candidate service provider terminals. The request sending module 340 may rank the probabilities in an ascending or a descending order. The request sending module 340 may determine a maximal probability among the probabilities associated with the plurality of candidate service provider terminals. The request sending module 340 may then determine the target service provider terminal corresponding to the maximal probability. For example, there are three candidate service provider terminals D, E, and F, where the candidate service provider terminal D corresponds to a probability of 0.9, the candidate service provider terminal E corresponds to a probability of 0.2, and the candidate service provider terminal F corresponds to a probability of 0.7. The request sending module 340 may determine the probability of 0.9 as the maximal probability. The request sending module 340 may determine the candidate service provider terminal D as the target service provider terminal.

In step 730, the request sending module 340 may send the request for the service to the target service provider terminal. In some embodiments, the request sending module 340 may send the request for the service through a wired connection or a wireless connection.

In some embodiments, the target service provider terminal may correspond to a service provider. Due to familiarity with the destination, the service provider may provide a convenient and efficient service to the passenger. For example, the service provider may have knowledge of the road network and landmarks near the destination, and thus, the service provider may have more confidence in driving the passenger from his/her departure location to the destination.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Pen, COBOL 2002, PHP, ABAP, dynamic programming languages such as Python, Ruby and Groovy, or other programming languages. The program code may execute entirely on the users computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter lie in less than all features of a single foregoing disclosed embodiment.

1. A system configured to operate an online on-demand transportation service, comprising:
a bus;
at least one storage medium connected with the bus, including a set of instructions;
logic circuits in communication with the at least one storage medium via the bus, wherein when executing the instructions, the logic circuits is directed to:
receive electronic signals including a request for a service including a destination;
obtain electronic signals including an area associated with a service provider terminal;
produce electronic currents corresponding to a probability that the destination is within the area associated with the service provider terminal;
determine whether the probability that the destination is within the area associated with the service provider terminal is larger than a threshold; and
in response to the determination that the probability that the destination is within the area associated with the service provider terminal is larger than the threshold, identify the service provider terminal as a candidate service provider terminal.

2. The system of claim 1, wherein the destination includes at least one of geographical coordinates or an address description.

3. The system of claim 1, wherein the logic circuits are further directed to:
obtain a plurality of historical locations associated with the service provider terminal;
determine a distribution model based on the plurality of historical locations; and
determine the area associated with the service provider terminal based on the distribution model.

4. The system of claim 3, wherein the plurality of historical locations includes a plurality of historical geographical coordinates of the service provider terminal.

5. The system of claim 3, wherein the distribution model is a two-dimensional normal distribution function.

6. The system of claim 3, wherein the logic circuits are further directed to:
determine a probability-dense region of the distribution model as the area associated with the service provider terminal.

7. The system of claim 3, wherein the logic circuits are further directed to:
obtain a longitude coordinate and a latitude coordinate of the destination; and
determine the probability that the destination is within the area associated with the service provider terminal based on the distribution model, the longitude coordinate of the destination, and the latitude coordinate of the destination.

8. The system of claim 1, wherein the logic circuits are further directed to:
send the request for the service to the candidate service provider terminal.

9. The system of claim 1, wherein the logic circuits are further directed to:
determine a plurality of candidate service provider terminals, wherein each of the plurality of candidate service provider terminals has an area, and a probability that the destination is within the area is larger than the threshold;
determine, among the plurality of candidate service provider terminals, a target service provider terminal associated with a significant area that has a maximal probability that the destination is within the significant area; and
send the request for the service to the target service provider terminal.

10. A method configured to operate an online on-demand transportation service on at least one electronic device having logic circuits, at least one storage medium, and a communication platform connected to a network, comprising:
receiving, by the logic circuits, a request for a service including a destination;
obtaining, by the logic circuits, an area associated with a service provider terminal;
outputting, by the logic circuits, electronic currents corresponding to a probability that the destination is within the area associated with the service provider terminal;
determining, by the logic circuits, whether the probability that the destination is within the area associated with the service provider terminal is larger than a threshold; and
in response to the determination that the probability that the destination is within the area associated with the service provider terminal is larger than the threshold, identifying, by the logic circuits, the service provider terminal as a candidate service provider terminal.

11. The method of claim 10, wherein the destination includes at least one of geographical coordinates or an address description.

12. The method of claim 10, further comprising:
obtaining a plurality of historical locations associated with the service provider terminal;
determining a distribution model based on the plurality of historical locations; and
determining the area associated with the service provider terminal based on the distribution model.

13. The method of claim 12, wherein the plurality of historical locations includes a plurality of historical geographical coordinates of the service provider terminal.

14. The method of claim 12, wherein the distribution model is a two-dimensional normal distribution function.

15. The method of claim 12, further comprising:
determining a probability-dense region of the distribution model as the area associated with the service provider terminal.

16. The method of claim 9, further comprising:
obtaining a longitude coordinate and a latitude coordinate of the destination; and
determining the probability that the destination is within the area associated with the service provider terminal based on the distribution model, the longitude coordinate of the destination, and the latitude coordinate of the destination.

17. The method of claim 10, further comprising:
sending the request for the service to the candidate service provider terminal.

18. The method of claim 10, further comprising:
determine a plurality of candidate service provider terminals, wherein each of the plurality of candidate service provider terminals has an area, and a probability that the destination is within the area is larger than the threshold;
determining, among the plurality of candidate service provider terminals, a target service provider terminal associated with a significant area that has a maximal probability that the destination is within the significant area; and
sending the request for the service to the target service provider terminal.

19. A non-transitory storage medium embodying a program product, the program product comprising instruction configured to operate an online on-demand transportation service on at least one electronic device, wherein when executed by logic circuits of at least one electronic device, the instructions cause the logic circuits to perform operations of:
receiving a request for a service including a destination;
obtaining an area associated with a service provider terminal;
outputting electronic current corresponding to a probability that the destination is within the area associated with the service provider terminal;
determine whether the probability that the destination is within the area associated with the service provider terminal is larger than a threshold; and
in response to the determination that the probability that the destination is within the area associated with the service provider terminal is larger than the threshold, identifying the service provider terminal as a candidate service provider terminal.

20. The non-transitory computer readable medium of claim 19, wherein the destination includes at least one of geographical coordinates or an address description.

21-27. (canceled)
